(19) United States
(12) Patent Application Publication
(10) Pub. No.: US 2025/0028526 A1
(43) Pub. Date: Jan. 23, 2025

(54) CHANGING SOFTWARE VERSIONS OPERATING BASED ON CONFIGURATION DATA DEPLOYED IN A DISTRIBUTED SYSTEM WHILE PROVIDING CONTINUED SERVICES

(71) Applicant: YugabyteDB, Inc., Sunnyvale, CA (US)

(72) Inventors: Hari Krishna Sunder, Sunnyvale, CA (US); Sandeep Lingam, Sunnyvale, CA (US); Bogdan-Alexandru Matican, Sunnyvale, CA (US); Raghavendra Thallam Kodandaramaih, Sunnyvale, CA (US); Kannan Muthukkaruppan, Sunnyvale, CA (US); Mikhail Andreyevich Bautin, Sunnyvale, CA (US)

(21) Appl. No.: 18/432,110

(22) Filed: Feb. 5, 2024

Related U.S. Application Data
(60) Provisional application No. 63/513,901, filed on Jul. 17, 2023.

(51) Int. Cl. G06F 8/71

(52) U.S. Cl. CPC G06F 8/71

(57) ABSTRACT

Aspects of the present disclosure facilitate changing software versions operating based on configuration data deployed in a distributed system while providing continued services. In one embodiment, a node of the distributed system operates a first version of a software module based on a first set of values for a set of configuration flags. Upon receiving a change request to change the software module to a second version and specifying a second set of values for the set of configuration flags, the node modifies the software module from the first version to the second version and operates the second version of the software module based on the first set of values for the set of configuration flags. After receiving an indication to promote the set of configuration flags, the node operates the second version of the software module based on the second set of values for the configuration flags.

### PRIORITY CLAIM

The present patent application is related to and claims the benefit of priority to the co-pending US provisional patent application entitled, “UPGRADING CONFIGURATION DATA CONTROLLED SOFTWARE DEPLOYED ON NODES OF A CLUSTER”, Ser. No. 63/513,901, Filed: 17 Jul. 2023, which is incorporated in its entirety herewith to the extent not inconsistent with the description herein.

### BACKGROUND OF THE DISCLOSURE

### Technical Field

The present disclosure relates to distributed computing and more specifically to changing software versions operating based on configuration data deployed in a distributed system while providing continued services.

### Related Art

Distributed system refers to a collection of computing nodes that operate together to provide a common/shared functionality (e.g., banking system, ERP system). Software components (together providing application/data services) are deployed in the computing nodes, typically with multiple instances of the (same) software being deployed in respective separate nodes for enhanced scale and reliability. The computing nodes communicate and coordinate their actions (for example, by passing messages to one another) to process the requests received from external client systems.

Software versions are often employed to update/modify a software, for example, to improve the implementation of the software, to fix previously discovered issues, to provide additional security, etc. Software versions are typically given ascending numerical values, with a higher numerical value indicating a newer version and a lower numerical value indicating an older version. Changing the software versions in a distributed system entails deploying a second version (e.g. newer version) of the software (component) in the computing nodes to replace a first version (e.g. older version) of the software previously deployed in the computing nodes.

Configuration data is commonly used to control the operation/execution of a software component (for example, when processing requests received from external client systems). Configuration data is typically specified external to the software, with different software versions operating based on the configuration data. Configuration data may contain one or more configuration flags (having respective names), whose values determine the specific features or behaviors of the software component, including the first and second versions.

There is often a need to change software versions while the distributed system continues processing requests received from external client systems. Such a change, commonly referred to as rolling or online upgrade, ensures that there is no impact on the availability of the distributed system during the upgrade. Aspects of the present disclosure relate to changing software versions (operating based on configuration data) deployed in a distributed system while providing continued services.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIGS. 2A-2C are flow charts illustrating the manner in which changing software versions operating based on configuration data deployed in a distributed system while providing continued service is facilitated according to aspects of the present disclosure.

FIG. 3A depicts the internal details of a distributed database (example distributed system) in one embodiment.

FIG. 3B depicts the manner in which distributed databases (example distributed systems) are hosted in multiple computing infrastructures in one embodiment.

FIGS. 4A-4D depict portions of configuration data (configuration flags) based on which software modules are operative in a distributed system (distributed database) in one embodiment.

FIG. 5 depicts a timeline of operation of a software module deployed in a distributed system in one embodiment.

FIG. 6 is a block diagram illustrating the details of a digital processing system in which various aspects of the present disclosure are operative by execution of appropriate executable modules.

In the drawings, similar reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

Aspects of the present disclosure facilitate changing software versions operating based on configuration data deployed in a distributed system while providing continued services. According to one aspect, a node of a distributed system operates a first version of a software module based on a first set of values for a set of configuration flags (contained in the configuration data). Upon receiving a change request to change the software module to a second version, the change request specifying a second set of values for the set of configuration flags, the node modifies, at a first time instance, the software module from the first version to the second version and operates the second version of the software module, after the first time instance, based on the first set of values for the set of configuration flags. After receiving, at a second time instance after the first time instance, an indication to promote the set of configuration flags, the node operates the second version of the software module based on the second set of values for the configuration flags.

According to another aspect of the present disclosure, the software module is an instance of multiple instances of a software component, the multiple instances being deployed on respective nodes in the distributed system, the respective nodes including the node. The indication (noted above) is received after the completion of the modifying of all instances of the software component from the first version to the second version.

According to one more aspect of the present disclosure, the software component is part of a distributed database deployed in the distributed system, the distributed database when operative in the distributed system providing a distributed data service. As such, the distributed data service is continued to be provided by the distributed system while the multiple instances of the software component are modified from the first version to the second version.

According to yet another aspect of the present disclosure, a first configuration flag of the set of configuration flags is set to a first value in the first set of values and a second value in the second set of values, the first value and the second value respectively indicating a first data format and a second data format, the first data format being different from the second data format. As such, the second version of the software module operates with the first data format prior to the indication in view of the first configuration flag being set to the first value and with the second data format after receipt of the indication in view of the first configuration flag being set to the second value.

In one embodiment, the first data format and the second data format are related to one of data formats used to send data within nodes of the distributed system, data formats used to persist the data in the distributed system and data formats used to communicate with systems external to the distributed system.

According to one more aspect of the present disclosure, the operating the first version and the second version of the software module comprises processing requests based on a set of current values for the set of configuration flags. As such, the set of current values is defined to equal the first set of values prior to the indication and defined to equal the second set of values after receipt of the indication.

According to yet another aspect of the present disclosure, the node (of the distributed system) maintains, in a memory in response to the change request, the second set of values and a set of promoted states corresponding to the set of configuration flags, each of the set of promoted states set to a first value indicating that the corresponding configuration flag has not been promoted. In response to the indication, the node checks which of the set of promoted states is set to the first value and for each promoted state set to the first value, the node sets the current value of the corresponding configuration flag to the corresponding value from the second set of values and the promoted state to a second value indicating that the corresponding configuration flag has been promoted.

According to an aspect of the present disclosure, a node of a distributed system receives a change request to change a software module from a first version to a second version, the software module being operative based on values for a set of configuration flags, the change request specifying a set of initial values and a set of target values for the set of configuration flags. In response to the change request, the node modifies, by a first time instance, the software module from the first version to the second version and operates the second version of the software module, after the first time instance, based on the set of initial values for the set of configuration flags. After receiving, at a second time instance after the first time instance, an indication to promote the set of configuration flags, the node operates the second version of the software module based on the set of target values for the configuration flags.

According to one more aspect of the present disclosure, the change request (noted above) is received at a third time instance prior to the first time instance, wherein prior to the third time instance, the software module is operating based on a third set of values for the set of configuration flags. The third set of values are ignored when operating the second version of the software module after the first time instance.

According to another aspect of the present disclosure, a second configuration flag of the set of configuration flags (noted above) is set to an initial value in the set of initial values and a target value in the set of target values, the initial value indicating that a new feature is disabled, and the target value indicating that the new feature is enabled. As such, the second version of the software module operates with the new feature only after receipt of the indication in view of the second configuration flag being set to the initial value prior to the indication and to the target value after receipt of the indication.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

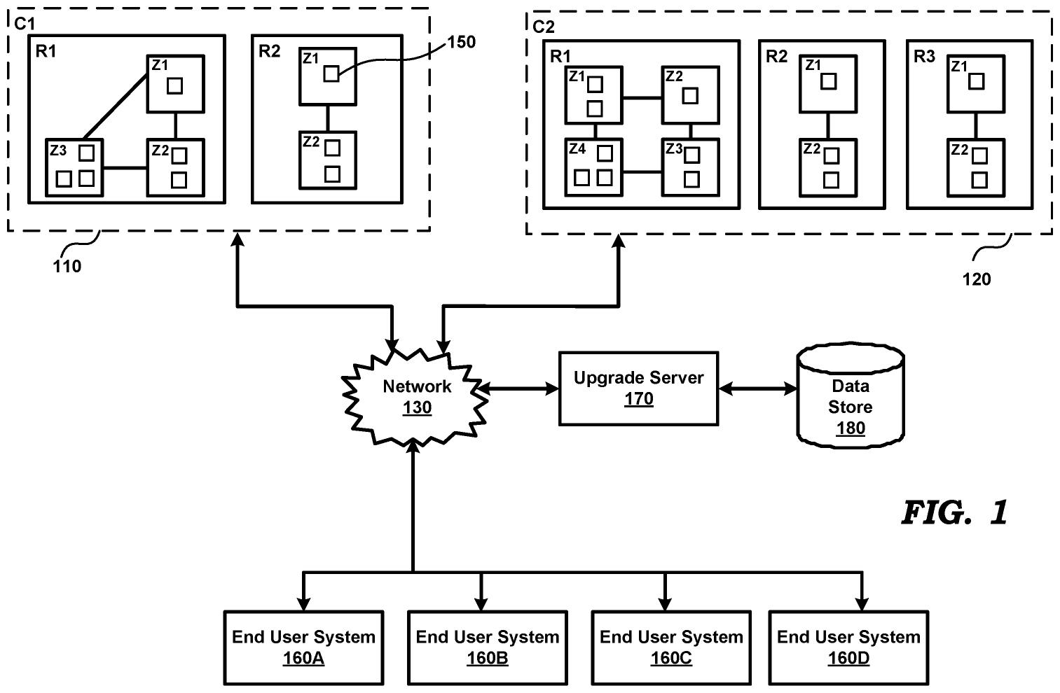

FIG. 1 is a block diagram illustrating an example environment (computing system) in which several aspects of the present disclosure can be implemented. The block diagram is shown containing computing infrastructures 110 and 120, network 130, node 150, end user systems 160A-160D, upgrade server 170, and data store 180. The end user systems are collectively referred to as 160.

Merely for illustration, only representative number/type of blocks is shown in the FIG. 1. Many environments often contain many more blocks, both in number and type, depending on the purpose for which the environment is designed. Each block of FIG. 1 is described below in further detail.

Each of computing infrastructures 110 and 120 is a collection of processing nodes, connectivity infrastructure, data storages, etc., which are engineered to together provide a virtual computing infrastructure for various customers, with the scale of such computing infrastructure being specified often on demand. The nodes (such as node 150) may be virtual nodes (e.g., virtual machines (VMs), containers containing one or more VMs) operating based on physical nodes, physical nodes themselves, or a combination as well.

It may be appreciated that the computing infrastructures typically span several continents and are provided by different vendors. In addition, each computing infrastructure may vary substantially from another in terms of interface requirements, scale, technical characters of nodes, hardware/software/network implementation, etc., and thus the computing infrastructures are said to be diverse. Examples of such diverse computing infrastructures include, but are not limited to, public clouds such as Amazon Web Services (AWS) Cloud available from Amazon.com, Inc., Google Cloud Platform (GCP) available from Google LLC, etc., and private clouds such as On-Premises clouds owned by the customers.

Computing infrastructure (C1) 110 is shown containing nodes (processing or storage, shown as squares such as node 150) located in two different geographical regions R1 and R2. Each region is shown containing multiple availability zones (named as Z1, Z2, etc.), each having independent support infrastructure such as power, networking, etc. Each availability zone (e.g., C1-R1-Z1) can thus operate independent of other zones, such that the availability zone can continue to operate even upon the failure of the other zones (e.g., C1-R1-Z2 and C1-R1-Z3). Computing infrastructure (C2) 120 is similarly shown with regions R1, R3, R4 with respective regional sets of availability zones, with each availability zone containing respective nodes.

All the nodes of each computing infrastructure 110/120 are assumed to be connected via a corresponding intranet (not shown). Network 130 extends the connectivity of these (and other systems of the computing infrastructures) with external systems such as end user systems 160, upgrade server 170 and data store 180. Network 130 may be an internetwork (including the world-wide connected Internet), an intranet, or a combination of internetwork and intranet. Each of the intranets and network 130 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 130. When the packet contains content such as port numbers, which specifies a target application, the packet may be said to be directed to such application as well.

Each of end user systems 160A-160D represents a system such as a personal computer, workstation, mobile device, computing tablet etc., used by users/customers to generate user requests directed to applications executing in upgrade server 170 or nodes of computing infrastructures 110/120. The user requests may be generated using appropriate user interfaces (e.g., web pages provided by an application executing in the server, a native user interface provided by a portion of an application downloaded from the server, etc.). In general, end user system requests an application for performing desired tasks and receives the corresponding responses (e.g., web pages) containing the results of performance of the requested tasks. The web pages/responses may then be presented to the user at end user systems 160 by client applications such as the browser.

Some of nodes in computing infrastructure 110/120 (and data store 180) may be implemented as corresponding data stores. Each data store represents a non-volatile (persistent) storage facilitating storage and retrieval of data by application services executing in the other systems/nodes of computing infrastructures 110/120 or upgrade server 170. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes in computing infrastructure 110/120 (and upgrade server 170) may be implemented as corresponding server systems. Each server system represents a server, such as a web/application server, constituted of appropriate hardware, executing application/data services or software components thereof capable of performing one or more tasks. The tasks may be specified as part of user requests received from end user systems 160 or node requests received from nodes of same/other computing infrastructures. A server system, in general, receives a task request and performs the tasks requested in the task request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end user system (one of 160) or node as a corresponding response to the task request. The results may be accompanied by specific user interfaces (e.g., web pages) for displaying the results to a requesting user.

In one embodiment, a collection of nodes from the various nodes of computing infrastructures 110/120 operate together as a distributed system providing a common/shared functionality. Software components (typically, part of a distributed software such as a distributed database), with desired duplicate instances of the same software component, are accordingly deployed in the collection of nodes. The software components may be operating based on configuration data (containing one or more configuration flags) that controls the operation/execution of the software components. The software components (corresponding nodes) communicate and coordinate their actions (for example, by passing messages to one another) to process the user requests received from end user systems 160. It may be desirable that the versions of the software components in such a distributed system be changed, while the distributed system continues to process user requests received from end user system 160.

Node 150, provided according to several aspects of the present disclosure, facilitates changing software versions operating based on configuration data deployed in a distributed system while providing continued service. Though described below with respect to node 150 below, it may be appreciated that the same aspects may be implemented in other nodes of computing infrastructures 110/120 as well. The manner in which node 150 facilitates the changing of software versions is described below with examples.

### 3. Changing Software Versions Deployed in a Distributed System

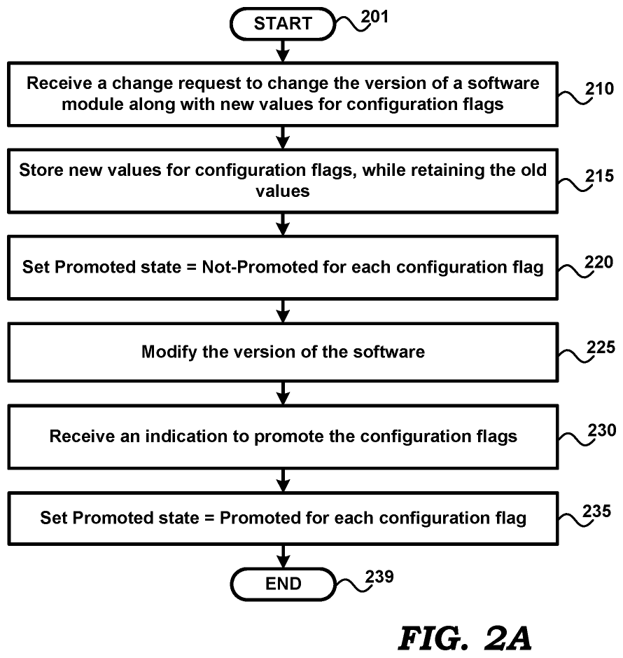

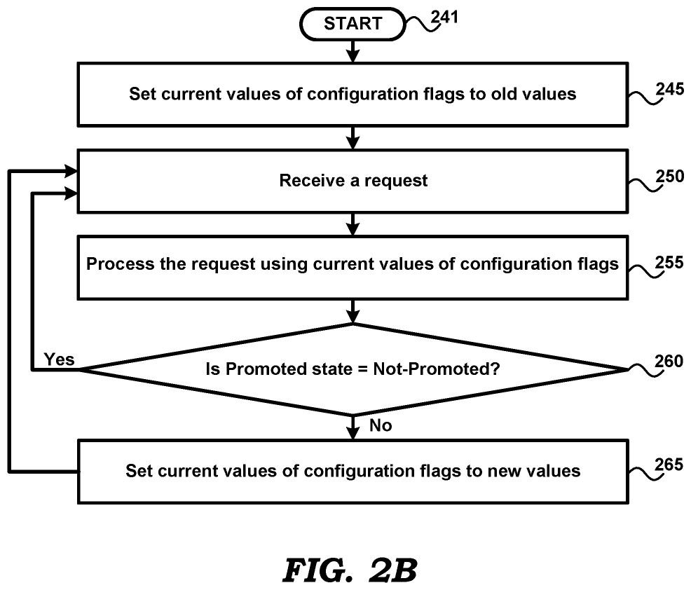

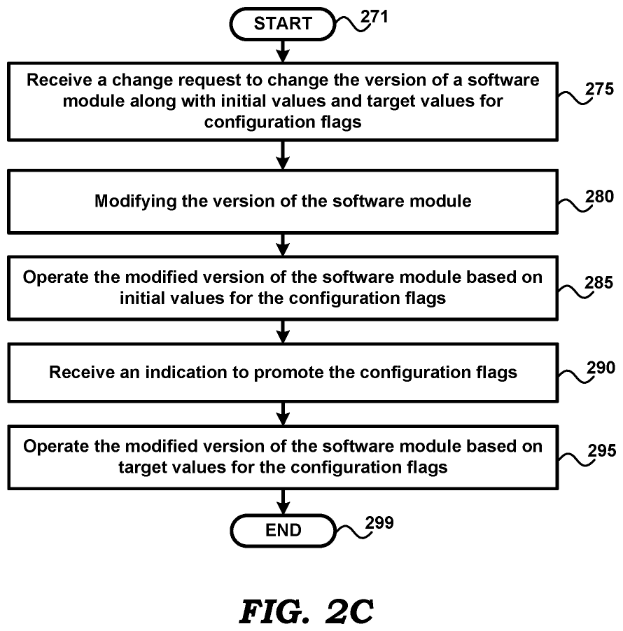

FIGS. 2A-2C are flow charts illustrating the manner in which changing software versions operating based on configuration data deployed in a distributed system while providing continued service is facilitated according to aspects of the present disclosure. The flowcharts are described with respect to the systems of FIG. 1, in particular node 150 and upgrade server 170, merely for illustration. However, many of the features can be implemented in other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. Each of the flowcharts is described in detail below.

Referring to FIG. 2A, the flow chart begins in step 201, in which control immediately passes to step 210. In step 210, node 150 receives a change request to change the version (from a first version to a second version) of a software module along with new values for configuration flags. The change request may be received from one of end user systems 160. The configuration flags may already be present in node 150 and may be used to control the operation of the first version of the software module already deployed in node 150. The new values of the configuration flags control the operation/execution of the second version of the software module sought to be deployed.

According to an aspect, the software module is an instance of multiple instances of a software component (of a distributed software), the multiple instances being deployed on respective nodes (of computing infrastructure 110/120) in the distributed system, the respective nodes including node 150.

In step 215, node 150 stores the new values for configuration flags, while retaining the old values. In one embodiment, the old values of the configuration flags refer to the values based on which the first version of the software module is operative. The new values and the old values may be stored in a memory within node 150 or in a persistent storage such as a hard disk associated with node 150, another node in computing infrastructures 110/120 operating as a data store or in data store 180.

In step 220, node 150 sets a promoted state to the value “Not-Promoted” for each configuration flag. The promoted state for each configuration flag may be implemented as a corresponding field, with the field set to a first value (e.g. “0”) to indicate the value “Not-Promoted” and to a second value (e.g. “1”) to indicate otherwise (to indicate the value “Promoted” as described below). The promote states may be maintained in a memory within node 150 or in a persistent storage such as a hard disk associated with node 150, another node in computing infrastructures 110/120 operating as a data store or in data store 180.

In step 225, node 150 modifies the version of the software module from the first version to the second version by deploying the appropriate version of the software module in node 150. The software/binary code forming the appropriate version of the software module may be downloaded/procured from other nodes of computing infrastructure 110/120 or from upgrade server 170.

In step 230, node 150 receives an indication to promote the configuration flags. The promote indication may be received from upgrade server 170 and/or from one of end user systems 160, for example, as part of a user request. According to an aspect, when the software module is an instance of multiple instances of a software component deployed on respective nodes of the distributed system, the indication is received after the completion of the modifying of all instances of the software component from the first version to the second version.

In step 235, node 150 sets the promoted state to the value “Promoted” for each configuration flag. As noted above, such setting may entail storing an appropriate value (here, “1”) in the fields corresponding to the promoted states maintained for the configuration flags. According to an aspect, node 150 checks which of the set of promoted states is set to a first value (here “0” indicating “Not-Promoted”) and for each such promoted state set to the first value, node 150 sets the promoted state to the value “Promoted” as noted above. Control passes to step 239, where the flowchart ends.

Thus, node 150 processes a change request to change the version (from the first version to the second version) of a software module. Though FIG. 2A is described above as being performed by a node (such as 150) of the distributed system, it may be appreciated that in alternative embodiments, the steps of FIG. 2A may be performed by upgrade server 170 (in association with data store 180) as will be apparent to a person skilled in the arts by reading the disclosure herein. The manner in which the second version of the software module operating in node 150 processes requests (e.g., user request received from end user systems 160) is described below with examples.

### 4. Processing Requests by the Software Module

Referring to FIG. 2B, the flow chart begins in step 241, in which control immediately passes to step 245. In step 245, node 150 sets the current values of configuration flags to old values (retained in step 215). The second version of the software module is operative based on the current values of the configuration flags, that is the old values of the configuration flags.

In step 250, node 150 receives a request to be processed by the second version of the software module. The request may be a user request from one of end user systems 160m or may be a request from another node/software module of the distributed system or a request from other nodes of computing infrastructures 110/120. The request may specify desired tasks to be performed by node 150, in particular, the second version of the software module. In step 255, node 150 processes the request using current values of configuration flags, that is, performs the desired tasks according to the operation/execution flow specified by the old values of the configuration flags. Node 150 may thereafter send the result of performance of the desired tasks as a corresponding response to the requesting system (one of end user system 160 or nodes of computing infrastructure 110/120).

In step 260, node 150 checks whether the promoted state corresponding to each configuration flag is equal to “Not-Promoted”. Such checking may be performed by determining whether the field corresponding to the promoted stated has the appropriate value (e.g. “0”). Control passes to step 250 if the promoted state is determined to be “Not-Promoted”, and to step 265 otherwise. It may be appreciated that the steps 250-255-260-250 ensure that requests are processed using the old values for the configuration flags until the promoted state indicates that the configuration flags have been promoted.

In step 265, node 150 sets the current values of configuration flags to new values (received as part of the change request) in response to determining that all the configuration flags have been promoted (that is, the promoted state is equal to “Promoted”). Control passes to step 250, where subsequent requests are processed using the new values for the configuration flags.

Though explained herein as being done with respect to all the configuration flags, it may be appreciated that the steps of 260 and 265 in association with the control flow back to step 250 may be implemented with only a subset of configuration flags. For example, in step 260, some configuration flags may be determined to be “Not-Promoted”, while other configuration flags may be determined to be “Promoted”. In such a scenario, control passes to step 265 from step 260, and only the “Promoted” configuration flags current values are set to the new values. Control still passes to step 250, where subsequent requests are processed using a combination of old values and new values for the configuration flags.

It may be further appreciated that the flowcharts of FIGS. 2A and 2B may operate in parallel. Node 150, specifically, the second version of the software module may continue to process requests using the old values for the configuration flags (steps 250-255-260-250) until the steps 230-235 causes the promoted states corresponding to the configuration flags to be set to “Promoted”, which then causes the steps of 265-250-255 to be performed thereby causing the second/newer version of the software module to thereafter process requests using the new values for the configuration flags. When performed concurrently, techniques can be employed so that the check of step 260 occurs inherently due to step 235.

Thus, node 150 facilitates changing software versions operating based on configuration data deployed in a distributed system while providing continued services. It may be appreciated that the above aspects of the present disclosure are directed to existing configuration flags based on which the first version of the software module is operative in the distributed system.

It may be appreciated that configuration flags are generally used in scenarios where a task is to be fully done in a single node/service. Aspects of the present disclosure enable such existing configuration flags to be extended when a task requires multiple nodes/services to process parts of the task (typically implying that there is network communication and hence some data format change). For example, if there is a task that is to be executed on all node/services of the older version but only need to run in a subset of nodes/services in the newer version then existing configuration flags, extended according to aspects of the present disclosure, may be used to guarantee that when the transition (from older version to newer version) happens all nodes/services of the distributed system are on the new version and handle it appropriately.

According to an aspect, an (existing) configuration flag is set to an old value indicated a first data format and later, a new indicating second data format different from the first data format. As such, the second version of the software module operates with the first data format prior to the promote indication in view of the configuration flag being set to the old value and with the second data format after receipt of the promote indication in view of the configuration flag being set to the new value. In one embodiment, the first data format and the second data format are related to one of data formats used to send data within nodes of the distributed system, data formats used to persist the data in that distributed system and data formats used to communicate with systems external to the distributed system (such as end user systems 160).

It may be further appreciated that the techniques of FIGS. 2A and 2B are applicable when the values for the configuration flag used in the first version of the software module (old values) are applicable for the second version as well until the promote indication is received. However, there are at least two scenarios when such old values are not applicable: (A) when a configuration flag with the same name (identifier) is not present in the first version of the software module (in which case it is referred to as a new configuration flag); and (B) even if a configuration flag with a same name is present and is associated with an old value, that specific old value is not used (ignored) in the transition to the second version of the software module (in which case it is referred to as a modern configuration flag). The manner in which new/modern configuration flags are handled by node 150 according to several aspects of the present disclosure are described below with examples.

### 5. New/Modern Configuration Flags

Referring to FIG. 2C, the flow chart begins in step 271, in which control immediately passes to step 275. In step 275, node 150 receives a change request to change the version (from a first version to a second version) of a software module along with initial values and target values for configuration flags. The change request may be received from one of end user systems 160. Each target value is desired to be the eventual value (after promote indication) based on which the second version of the software module is to be operative, and the initial value is the transient value to be used until the promote indication is received.

In step 280, node 150 modifies the version of the software module from the first version to the second version by deploying the appropriate version of the software module in node 150, similar to step 225 of FIG. 2A noted above.

Prior to modifying the version, node 150 may store the received initial value and target values in a memory and set a promoted state to “Not-Promoted” for each configuration flag specified in the change request (similar to steps 215 and 220 of FIG. 2A).

In step 285, node 150 operates the modified/second version of the software module based on initial values for the configuration flags. Such operation may entails setting the current values of the configuration flags to be equal to the corresponding initial values received as part of the change request (similar to step 245 of FIG. 2B).

In step 290, node 150 receives an indication to promote the configuration flags. The promote indication may be received as in step 230 of FIG. 2A, from upgrade server 170 and/or from one of end user systems 160, for example, as part of a user request. Node 150 may also set the promote state for each configuration flag to “Promoted” (similar to step 235 of FIG. 2B).

In step 295, node 150 operates the modified/second version of the software module based on target values for the configuration flags. Such operation may entails setting the current values of the configuration flags to be equal to the corresponding target values received as part of the change request (similar to step 265 of FIG. 2B).

In other words, the current values of the configuration flags are set to the respective initial values (received as part of the change request). The initial values act as transient values for the configuration flags until the promote indication is received. After receipt of the indication (that is, promoted state=“Promoted”) in step 290, the current values of the configuration flags are set to the respective target values (received as part of the change request).

Accordingly, node 150, specifically, the second version of the software module, continues to process requests (e.g., user requests received from end user systems 160) using the initial values for the configuration flags (steps 250-255-260-250) prior to the promote indication, and operates based the target values for the configuration flags (steps 265-250-255) after receipt of the promoted indication.

Thus, it may be appreciated that node 150 handles new configuration flags noted above under scenario (A). Similar technique can be used for modern configuration flags in case of scenario (B) as well. In other words, even in this scenario, the initial values received in the change request are used in the transient duration (ignoring the old values for that modern configuration flags).

It may be further appreciated the such new/modern configuration flags are typically used to enable/disable new features available in the second version of the software module. For example, the new configuration flags may be used to change the encoding type. An older/first version of the software module may have only encoding type A (and accordingly no requirement for a configuration flag). However, a newer/second version of the software module may have toe different encoding types (type A and type B) and it may be desirable that the distributed system switches to type B safely (after all nodes are on the newer version have been modified to understand type B). Similar approach may be employed for different encryption techniques and compaction techniques.

According to an aspect, a new configuration flag is received along with a corresponding initial value (indicating that the new feature is disabled) and a corresponding target value (indicating that the new feature is enabled). As such, the second version of the software module operates with the new feature only after receipt of the promote indication in view of the configuration flag being set to the corresponding initial value prior to the indication and to the corresponding target value after receipt of the indication.

Node 150 accordingly handles both new/modern and existing configuration flags to ensure that the software versions of the software module are changed while the distributed system continues to provide services (e.g., process user requests received from end user systems 160). The manner in which node 150 provides several aspects of the present disclosure according to the steps of FIGS. 2A-2C is described below with examples.

### 6. Illustrative Example

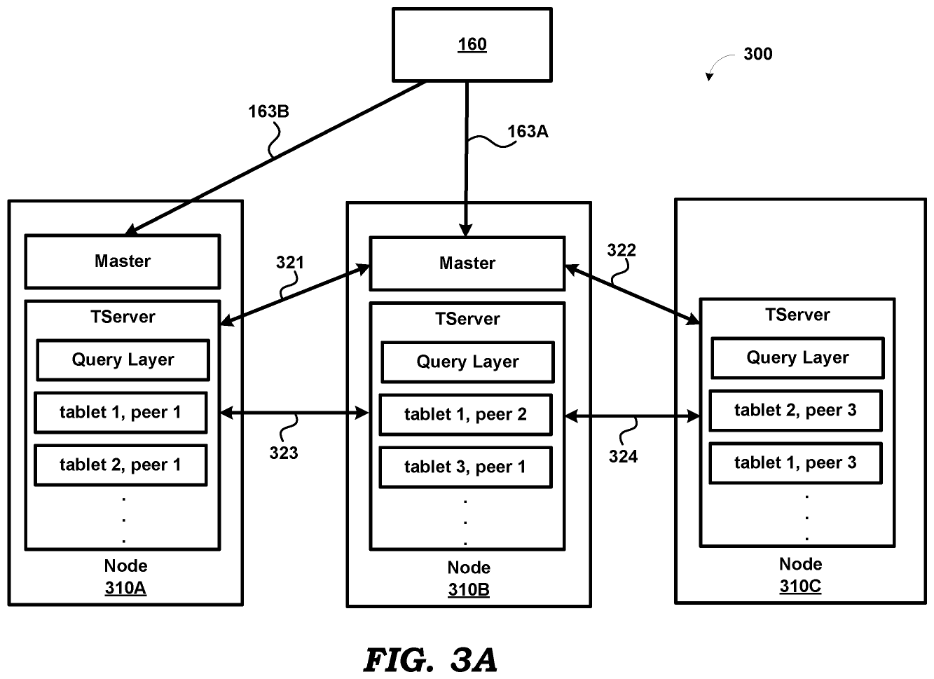

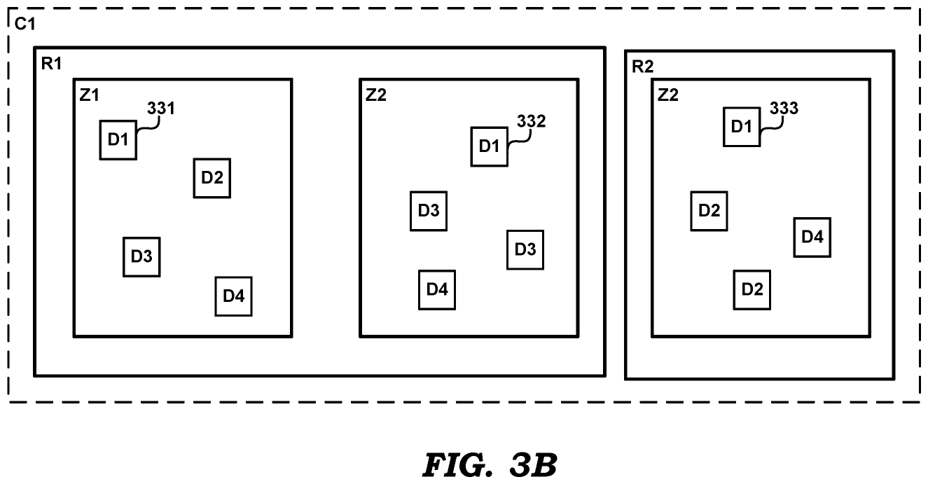

FIGS. 3A-3B, 4A-4D and 5 illustrate the manner in which changing software versions operating based on configuration data deployed in a distributed system while providing continued service is facilitated in one embodiment. Each of the Figures is described in detail below.

In the following description, changing software versions may refer to an “Upgrade” where a newer version of the software is deployed in the computing nodes, a “Downgrade” where an older version of the software is deployed in the computing nodes, or a “Rollback” where a current (typically newer) version of the software is replaced by a previously used (typically older) version in the computing nodes. As such, the modifying of the version of a software module in node 150 may result in an upgrade, downgrade, or rollback of the software module. Aspects of the present disclosure are described below with respect to upgrade of the software, though these aspects are applicable for downgrade and rollback of the software as well as will be apparent to one skilled in the relevant arts by reading the disclosure herein.

In one embodiment, aspects of the present disclosure facilitate users/customers to change software versions of distributed data services deployed in computing infrastructures (such as 110 and 120). Data services refer to implementations designed to provide access (storage and retrieval) to basic data using data storages. The basic data can be used by higher level applications such as electronic mail, enterprise applications, etc., as is well known in the relevant arts. Common examples of such data services are databases and file systems. Data services are referred to as ‘data as a service’ (DaaS) in several environments.

In the following sections, several aspects of the present disclosure are illustrated with respect to a distributed database as an example of a distributed data service. However, the features of the present disclosure may be implemented with respect to other data services (e.g., file server, replicated databases) as well, as will be apparent to one skilled in the relevant arts by reading the disclosure herein.

As is well known, a distributed database is often implemented based on multiple nodes (of computing infrastructures 110/120) that cooperatively provide a unified view of database interfaces, while shielding the users from the underlying storage and processing of data. Distributed databases thus provide for fault tolerance (of nodes or storage), enhanced performance, data redundancy (by a replication factor), etc., as is well known in the relevant arts. The manner in which a distributed database may be deployed in the nodes of computing infrastructures (such as 110 and 120) is described below with examples.

### 7. Distributed Database

FIG. 3A depicts the internal details of a distributed database (example distributed system) in one embodiment. Distributed database 300 is a cluster of nodes such as VMs, physical machines or containers (referred to as a “universe”) that collectively function as a highly available and resilient distributed database. For illustration, the universe of distributed database 300 is shown containing three nodes 310A-310C, though in alternative embodiments, distributed databases contain fewer or more nodes depending on the purpose for which the database is designed.

Distributed database 300 is a system-of-record/authoritative database that geo-distributed applications can rely on for correctness and availability. Distributed database 300 allows applications to easily scale up and scale down across multiple regions in the public cloud, on-premises data centers or across hybrid environments without creating operational complexity or increasing the risk of outages.

Distributed database 300 may be deployed in a variety of configurations depending on business requirements, and latency considerations. Some examples are single availability zone (zone/rack/failure domain), multiple availability zones in a region, multiple regions (with synchronous and asynchronous replication choices), etc. An example of such a distributed database is YugaByte DB available from YugaByteDB, Inc.

In one embodiment, the universe of distributed database 300 consists of one or more keyspaces, with each keyspace being a namespace that can contain one or more database tables. Distributed database 300 automatically shards, replicates and load-balances these database tables across the nodes in the universe, while respecting user-intent such as cross-AZ or region placement requirements, desired replication factor, and so on. Distributed database 300 automatically handles failures (e.g., node, availability zone or region failures), and re-distributes and re-replicates data back to desired levels across the remaining available nodes while still respecting any data placement requirements. The components of distributed database 300 are described in detail below.

Distributed database 300 has three components-Master process, TServer process and data storage. The Master (Server) processes are responsible for keeping system metadata/records, such as what tables exist in the system, where their tablets live, what users/roles exist, the permissions associated with them, etc. Master processes also are responsible for coordinating system-wide operations such as create/alter drop tables and initiating maintenance operations such as load-balancing or initiating re-replication of under-replicated data. The Master process' executing in the different nodes (310A-310B) are not in the critical path of IO against user tables (which is handled by TServer processes as described below).

The TServer processes are responsible for hosting/serving user data (e.g., database tables). Each TServer process does the actual IO for end user requests received (via paths 163A/163B) from user applications (executing in end user systems 160). The user requests may be according to the various protocols supported by distributed database 300. Query Layer, executing as part of each TServer process, implements the server-side of multiple protocols/APIs that distributed database 300 supports such as Apache Cassandra CQL, Redis APIs, SQL API, etc. The user data/database tables are maintained in the database storage (e.g. Postgres/Postgre SQL databases) in each node.

In one embodiment, each database table is split/sharded into one or more tablets based on groups of primary keys. Each tablet is composed of one or more tablet-peers depending on the replication factor, with each TServer process hosting one or more tablet-peers. The manner in which a table having one or more tablets with a replication factor of 3 (that is, 3 peers) may be maintained in nodes 310A-310C is depicted in FIG. 3A.

Each TServer process also coordinates operations across tablets (by sending messages via paths 321-324) hosted by it by using techniques such as server-global block cache (leading to highly efficient memory utilization in cases when one tablet is read more often than others), throttled compactions (to prevent high foreground latencies during a compaction storm), small/large compaction queues to keep the system functional even in extreme IO patterns, server-global memstore limits, auto-sizing of block cache/memstore, striping tablet load uniformly across data disks, etc.

In one embodiment, the Master and TServer processes use Raft, a distributed consensus algorithm, for replicating changes to system metadata or user data respectively across a set of nodes. The detail of the Raft consensus algorithm is available in the paper entitled “In Search of an Understandable Consensus Algorithm (Extended Version)” by Diego Ongaro and John Ousterhout of Stanford University. Specifically, the Master process' executing in the different nodes (310A-310B) forms a Raft group with its peers, while the tablet-peers (e.g. “tablet 1, peer 1”, “tablet 1, peer 2”, etc.) corresponding to each tablet (e.g. “tablet 1”) hosted on different TServers (in nodes 310A-310C) form a corresponding Raft group and replicate data between each other.

Thus, the Master and TServer processes along with the operation of Raft groups provides for a transactional, high performance distributed database (200) for planet-scale applications. It may be appreciated that multiple distributed databases similar to database 300 may be hosted by computing infrastructures 110 and 120. The manner in which multiple distributed databases may be hosted in multiple computing infrastructures is described in detail below.

FIG. 3B depicts the manner in which distributed databases (example distributed systems) are hosted in multiple computing infrastructures in one embodiment. For illustration, only a sample set of universes (hosting distributed databases) in a single computing infrastructure is shown in the Figure. However, the features of the present disclosure can be implemented for universes spanning multiple availability zones and/or regions and/or computing infrastructures, as will be apparent to one skilled in the relevant arts by reading the disclosure herein.

Specifically, four distributed data services labeled D1, D2, D3 and D4 are shown in FIG. 3B with the corresponding nodes (shown as squares) distributed among three availability zones Z1, Z2 and Z3 within geographical regions R1 and R2 in computing infrastructure C1. In the following description, data service D1 is assumed to correspond to distributed database 300.

Data service D1 is shown hosted by the universe of nodes 331-333 distributed among multiple availability zones and geographical regions to provide features such as fault tolerance, enhanced performance, data redundancy, etc. The other data services (D2, D3, etc.) are similarly shown hosted on corresponding sets of nodes labeled with the identifier of the data service (D2, D3, etc.).

It may be appreciated that each Master and TServer process may represent a software module (whose version may be sought to be changed). In the embodiment of FIG. 3A, the software module is an instance of multiple instances of a software component (Master/TServer), the multiple instances being deployed on respective nodes (nodes 310A-310C) in the distributed system (300). It may accordingly be desirable that a software module (e.g., instance of TServer) be operative with the new values/target values for configuration flags only after all the instances of the software component (here, TServer) have been modified from a first version to a second version. Some of the challenges to upgrading the various software components of a distributed database (300) are described below with examples.

### 8. Challenges to Upgrading a Distributed Database

As noted above, distributed database 300 is a distributed system with multiple processes (software modules) that require upgrades to be done in an online manner. The term “online” manner means that the processes will be communicating with each other, serving user queries (received from end user systems 160) and generating data while (concurrent with) the upgrade is in progress. At any point during the upgrade, there can be a mix of processes running both old and new code/versions. Introduction of new code paths, messages, or data formats require additional checks to ensure correct operation of the distributed system.

In a prior approach, a user/developer is required to manually (or using an appropriate script file) set the configuration flags to desired values (e.g., turning OFF the features of a newer version) prior to performing the upgrade. After performing the desired upgrade of all instances of a software component to the newer version, the user/developer again manually sets the configuration flags to the actual values (e.g., turning ON the features of the newer version) based on which the upgraded software is required to be operative. It should be noted that such manual operation does not have any checkpoints, which means users/customers can upgrade from any old release/version of the software module to any newer release/version. It may accordingly be unsafe to enable these configuration flags by default in code/software modules even for future releases/versions.

In addition, a distributed database can have configuration flags of the order of several hundreds, with the count of such configuration flags expected to keep increasing as more functionality and performance improvements are added. As such, the manual approach of above has several limitations, such as:
Relying on users/customers to manually run configuration flags upgrades after every version change is not optimal;
The out-of-box experience for new universe/distributed system will have reduced functionality and performance enabling features as the features of the newer version are not available due to the configuration flags being turned OFF;
Users/customers may never perform the final step of turning ON the features of the new version;
Users/customers may set incorrect configuration flags or incorrect values for the configuration flags due to human errors, which may result in unexpected behavior of the distributed system;
The above noted manual upgrade process has to be repeated in every universe/distributed system that the customer owns;
When certain features are enabled on a backported release then the universe (distributed system) should only upgrade to other releases which have the same features. Such a requirement is currently not tracked or enforced. Improper upgrades can potentially cause corruption of the distributed system.
Rollbacks, and Downgrades are unsafe and unsupported.

Several aspects of the present disclosure facilitate changing software versions operating based on configuration data deployed in a distributed system (distributed database 300) while providing continued service and overcoming the drawbacks noted above, as described below with examples.

### 9. Configuration Data in Distributed Database

According to several aspects of the present disclosure, configuration flags (that control the operation of software modules in distributed database 300) are provided with additional values, namely, initial and target values. In addition, each configuration flag is associated with a promoted stated that can have two values “Promoted” indicating that the configuration flag has been promoted and “Not-Promoted” indicating that the configuration flag has not been promoted. The current value of the configuration flag is set to the corresponding initial value in the “Not-Promoted” state and to the corresponding target value in the “Promoted” state. By such an operation, the changing of software version deployed in a distributed system which providing continued service is facilitated. Some sample configuration data used in a distributed system (such as distributed database 300) that provides several aspects of the present disclosure is described in detail

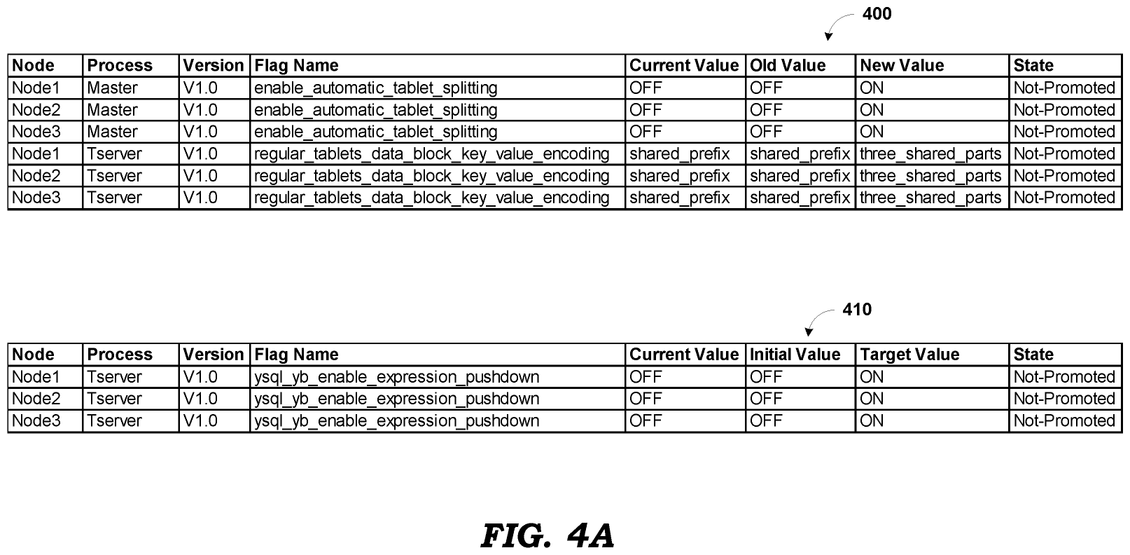

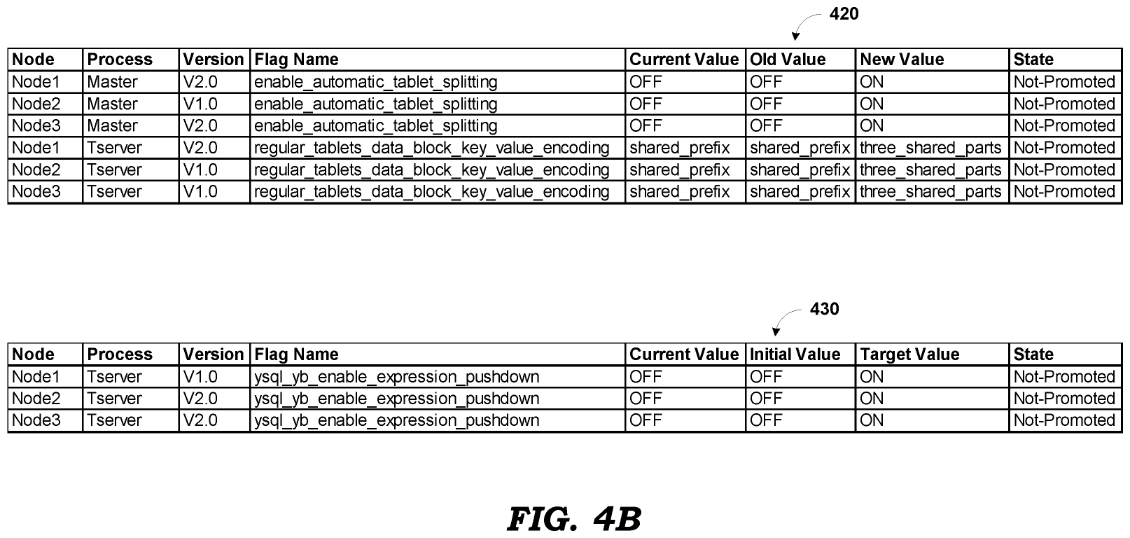

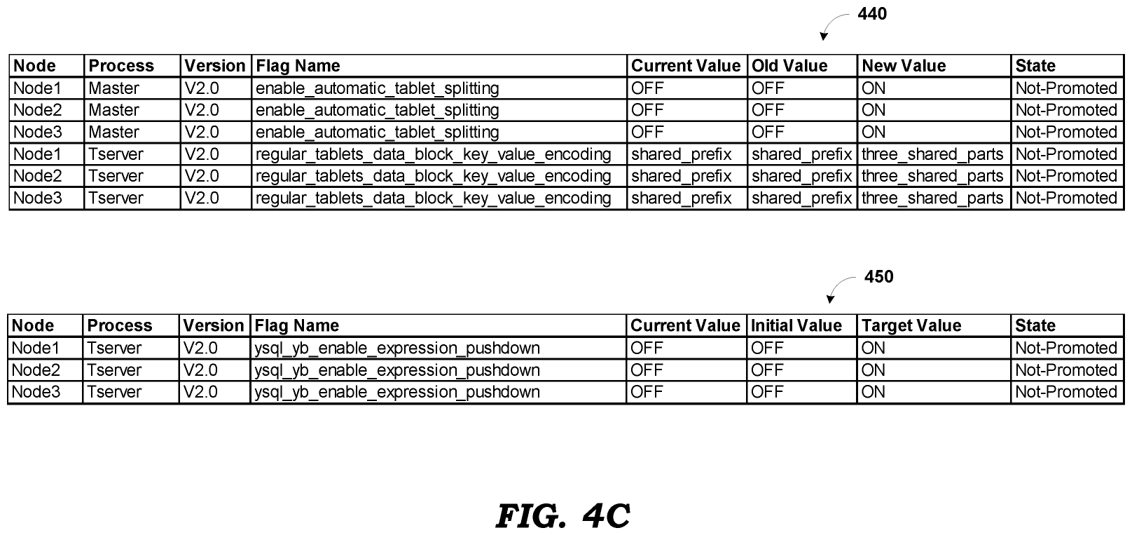

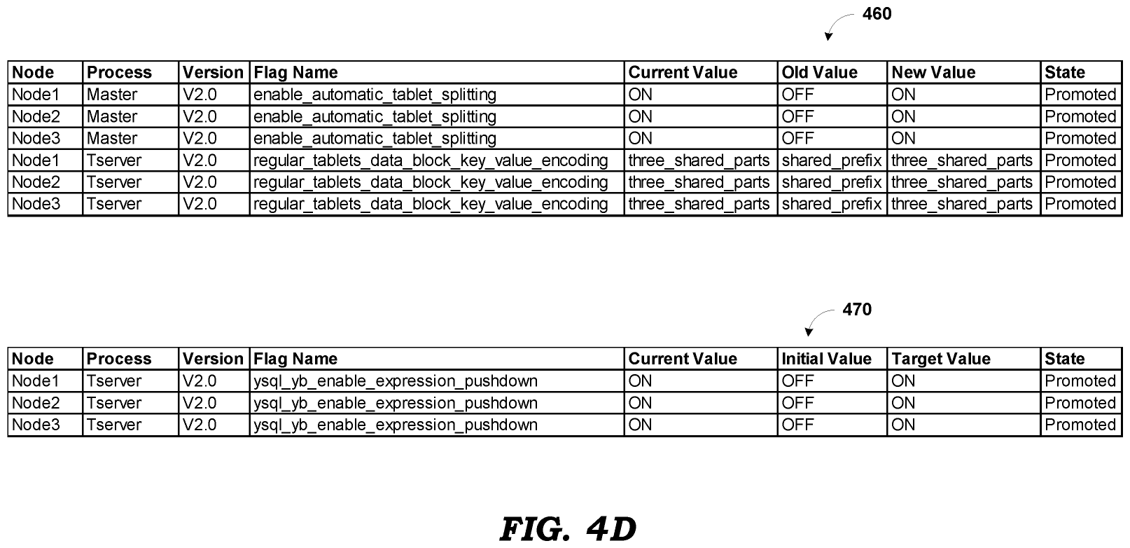

FIGS. 4A-4D depict portions of configuration data (configuration flags) based on which software modules are operative in a distributed system (distributed database 300) in one embodiment. For illustration, the configuration data is assumed to be maintained in the form of tables (for example, in data store 180). However, in alternative embodiments, the configuration data may be maintained according to other data formats (such as files according to extensible markup language (XML), etc.) and/or using other data structures (such as lists, trees, etc.), as will be apparent to one skilled in the relevant arts by reading the disclosure herein. Each of the Figures is described in detail below.

FIG. 4A depicts the configuration data in an initial state of distributed database 300 after receipt of a change request and prior to upgrading software versions. Specifically, table 400 depicts the details of existing configuration flags, while table 410 depicts the details of new/modern configuration flags. In both tables 400 and 410, column “Node” specifies the node such as 310A-310C in which the process/software module is deployed, column “Process” specifies the name of the software module, column “Version” specifies a current version number of the software module, column “Flag Name” specifies the name of the (existing or new) configuration flag, column “Current Value” specifies a current value for the corresponding configuration flag based on which the software module is operative in distributed database 300, and column “State” specifies whether the configuration flag is updated/promoted (value “Promoted”) or not (value “Not Promoted”).

In addition to the common columns, table 400 includes columns “Old Value” and “New Value” that respectively specify the old and new values for the existing configuration flag. It may be appreciated that the old values are the values used by the previous version of the software module, while the new values are received as part of the change request. On the other hand, table 410 includes columns “Initial Value” and “Target Value” that respectively specify the initial and target values for the new/modern configuration flag. It may be appreciated that the initial values and the target values are received as part of the change request for new/modern configuration flags.

It may be observed that for each configuration flag in table 400, the current value is set to the corresponding old value, while in table 410, the current value is set to the corresponding initial value. In one embodiment, the configuration flags are shown having Boolean values that are set to “OFF” during the upgrade, and turned “ON” only after all nodes/instances have been upgraded to the new version. However, in alternative embodiments, other types of configuration flags based on integers, floating point numbers or strings can be used to keep track of the upgrades.

Referring to FIG. 4B, tables 420 and 430 respectively depict the existing and new/modern configuration flags in an upgrading state of distributed database 300 during the process of upgrading of the processes/software modules. It may be observed that only some of the processes/software modules are indicated to be upgraded to version number 2.0 (in comparison the previous version number 1.0). The current value in both tables 420 and 430 still reflect the old value/initial value for the configuration flag.

Referring to FIG. 4C, tables 440 and 450 respectively depict the existing and new/modern configuration flags in an upgrade complete state of distributed database 300 after the process of upgrading of all the processes/software modules is completed (but promote indication is not yet received). It may be observed that all of the processes are indicated to be upgraded to version number 2.0, but the configuration flags are still indicated to be not updated (value “Not Promoted” in column “State”). The current value in both tables 440 and 450 still reflect the old value/initial value for the configuration flag.

Referring to FIG. 4D, tables 460 and 470 respectively depict the existing and new/modern configuration flags in a promoted state of distributed database 300 after the process of upgrading of all the processes/software modules is completed and promote indication has been received. Specifically, tables 460 and 470 indicate that all the configuration flags are updated/promoted (value “Promoted” in column “State”). It may be observed that for each configuration flag in table 460, the current value is set to the corresponding new value, while in table 470, the current value is set to the corresponding target value.

Thus, node 150 maintains configuration data based on which software versions are operative. The manner in which such configuration data affects the operation of a software module (of distributed database 300) to provide several aspects of the present disclosure is described below with examples.

### 10. Operation of a Software Module in a Distributed Database

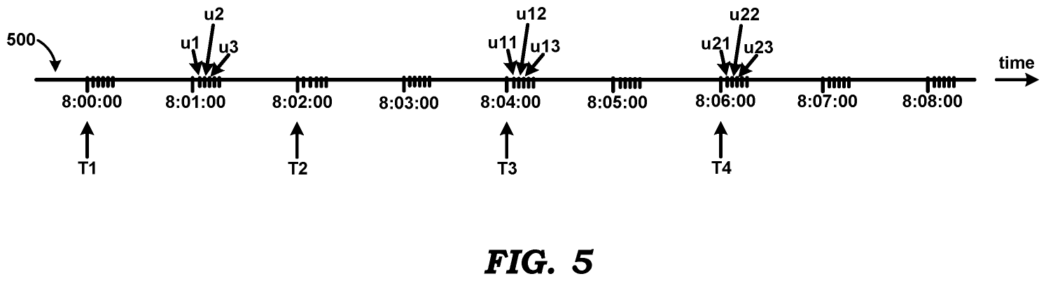

FIG. 5 depicts a timeline of operation of a software module deployed in a distributed system in one embodiment. Specifically, timeline 500 depicts the operation of a software module (e.g. Master process, TServer process) of distributed database 300 processing various user requests received from end user systems 160. For illustration, it is assumed that the user requests are received every second and accordingly timeline 500 is shown in seconds (as indicated by the 24-hour format “8:00:00”).

T1 represents a time instance (a point on timeline 500) at which an older/previous version of the software module is deployed on a node (e.g., 150) of the distributed system. The previous version of the software module according processes user requests u1, u2, u3 (received around “8:01:00”) based on the old values of existing configuration flags as shown in the configuration data of table 400 above.

T2 represents a time instance (“8:00:02”) at which a change request is received by node 150. The change request may indicate that an upgrade of the software module is to be performed. As noted above, in response to the change request, node 150 stores the old values and new values for existing configuration flags and the initial and target values for the new configuration flags (the configuration data of table 410) prior to performing the upgrade of the software module.

T3 represents a time instance (“8:00:04”) at which the upgrade of the software module (that is, modifying the software module from a first version to a second version) is completed. It should be noted that during the upgrade (that is between T2 and T3), no user requests are processed by the software module. However, after the upgrade of the software module is completed, the second/newer version of the software module processes user requests u11, u12, u13 (received after “8:04:00”) based on the old/initial values of configuration flags as shown in the configuration data of tables 420 and 430. Node 150 may continue to process user requests based on the old/initial values of configuration flags until all the instances of the software module/components are upgrades (as shown by the configuration data of tables 440 and 450)

T4 represents a time instance (“8:00:06”) at which a promote indication is received indicating that the configuration flags are to be promoted. In response, node 150 sets the current values of the configuration flags to the corresponding new/target values. Accordingly, the second/newer version of the software module processes user requests u21, u22, u23 (received after “8:06:00”) based on the new/target values of configuration flags as shown in the configuration data of tables 460 and 470.

Thus, the features of the present disclosure ensure that all of the configuration flags are set to the appropriate values both during upgrade and after the upgrade is completed, thereby overcoming some of the challenges noted above.

For example, instead of relying on users/customers to manually run configuration flags upgrades after every version change, a user/customer may need to run a single admin command that sends the promoted indication (noted above) to upgrade all the configuration flags at once. Such an admin command is the same for all software versions. Such an admin command may also be incorporated into upgrade workflow\scripts. In addition, when a new universe is created, all the configuration flags are in the promoted state (that is set to the target values), thereby ensuring that the out-of-box experience for a new universe/distributed system has all the functionality and performance enabling features of the newer version.

In one embodiment, the distributed system may perform a periodic check on whether there are “Not-Promoted” configuration flags for an extended period of time, and upon determining the existence of such configuration flags, sends alerts to users/administrators of the distributed system. It may be appreciated that since configuration flags are associated with corresponding new/target values to be used by the second version of the software module, human errors in setting the values of the configuration flags is avoided.

In one embodiment, the set of Promoted configuration flags is stored in a non-volatile memory (e.g., hard disk). When a process/software module restarts on a different version, the software module (node 150) first reads the saved config and validates that the different version has a superset of configuration flags compared to the saved config and crashes otherwise (when there is only a subset of configuration flags). Such an action prevents any corruption due to improper upgrades. The config from an existing universe can also be read and compared to the new version (every version has a list of configuration flags they support in a JSON file as part of the release build) even before the upgrade starts to prevent the crashes and provide a smoother user experience.

In addition to the above, it may be appreciated that the various features of the present disclosure enable the configuration flags to be used even for supporting rollbacks and downgrades. Some of the features of the configuration flags are described below with examples.

### 11. Configuration Flag Features

### Configuration Flag Classes

Each configuration flag belongs to a single workflow Class. Configuration flags is a universe level configuration that contains a list of promoted configuration flags for each process in the cluster. Tasks inside distributed database 300 can be anything from a user issuing a DML (database manipulation language), to a Tablet Split. The tasks may be simple and confined to a function block or span multiple universes. Tasks that modify the format of data need special care during Upgrade, Rollback and Downgrades. Based on the type of data and its usage pattern the tasks are divided into classes:

1. LocalVolatile: Addition or modification of data sent over the wire to another process within the same universe. No modification to persisted data. (New RPC, new PB, new enums in PB) Example configuration flags are enable_history_cutoff_propagation, yb_enable_expression_pushdown, tablet_report_limit. Upgrade safety: Safe to enable only after all processes in the universe have been upgraded to new code version. Nodes running the old version cannot join the distributed system after the task has been enabled. Downgrade safety: Safe to disable the feature and then downgrade to an older version.

2. LocalPersisted: Addition or modification of data that are persisted and used within the same universe. (New files, New page formats, New Superblock with a new required PB member, Bootstrap) E.g.: Tablet splitting range boundaries, prefix compression Update safety: Same as Class 1. Downgrade safety: Not safe to downgrade after the feature is enabled, as old code will not be able to understand the persisted data.

3. External: Addition or modification of data used outside the Universe. E.g.: CDCSDK Server, xCluster, Backups, Cross Cluster PITR, Packed Columns and Bootstrap. Update safety: Safe to enable only after all processes in the universe and dependent processes \universes outside this universe have been upgraded to new code. Nodes running the old version cannot join the cluster after the workflow has been enabled. Downgrade safety: Not safe to downgrade after the new feature is enabled, as old code will not be able to understand the data. (It is assumed that the external data is always persisted, and many external volatile features are not expected)

### Requirements for the Configuration Flags

The following are the requirements for configuration flags in distributed database 300:
1. New Universe should be created with all configuration flags in the Promoted state (target value).
2. Configuration flags (values) should not be lost if one or more processes \nodes restart. Or even when nodes are lost permanently as long as a quorum of masters still remains.
3. After a code upgrade, new configuration flags should automatically and safely get Promoted. Customers should not have to be concerned about flag names, their values or purpose.
4. The configuration flags configuration should get propagated to all processes in the universe in a reasonable amount of time (Heartbeat interval) when there is no network partitioning.
5. Customers should be able to override configuration flags with custom values. Such override takes precedence over the promoted state for the flag.
6. Zombie nodes-Nodes that could not be upgraded to the new code/version after the configuration flags are promoted should not be allowed to rejoin the distributed system.
7. Backport safety, and Rollforward protection—There should be an ability to backport the flags to a subset of old release versions. Upgrades to versions (which may have a higher number) that do not have the promoted configuration flag should be blocked. E.g.: New functionality was added to master and backported to release 2.6.2 and 2.8.10. The system can upgrade from 2.6.2 to 2.8.10, but cannot safely go from 2.6.2 to 2.8.9
8. Rollback protection-Once a Class LocalPersisted or External flag is enabled, system cannot rollback to a code version that does not contain the new/modern configuration flag. Processes that start with configuration flags that are incompatible with their code version should be blocked from joining the universe.

There may be additional requirements such as that the distributed system (e.g., node 150) should make sure there are no zombie nodes before new configuration flags are set. Also, for upgrade and rollback protection, the distributed system should block users/customers from performing incompatible upgrades. Requirements for OSS (open source software) deployments may include adding an extra step or and utility command to perform steps 1, 3, 4 noted above. OSS may not want things turned on automatically (step 4 above). Customers will be fully responsible for steps 5 and 7. In steps 8 and 9, customers should be able to use a utility tool to check if a build is safe to deploy.

### Properties of the Configuration Flags

Based on the above requirements, the configuration flags may have the following properties:
They can be backported to older versions safely.
They will be tagged as Runtime and Stable. Non-runtime flags should be extremely rare as they require a process restart.
Existing configuration flags can be converted to modern configuration flags.
They cannot be removed or renamed.
Flags can only transition from Not-Promoted to Promoted state. Never the other way around.

It may be appreciated that rollbacks may be optionally implemented. Upgrade safety checks—the distributed system has to detect when an upgrade is making the system unstable and stop it.

Thus, aspects of the present disclosure maintain for each configuration flag, a corresponding initial value, a corresponding target value and a corresponding promoted state indicating whether the configuration flag has been updated/promoted or not. After upgrade of all instances of a software component, a node determines the configuration flags that have not been updated based on the corresponding state and sets a current value of each determined configuration flag to the corresponding target value. The node also sets the promoted state of the determined configuration flag to indicate that the configuration flag has been updated. In addition, the aspects also ensure that the software components of the distributed database are upgraded and configured to operate with new upgrade features.

It should be appreciated that the features described above can be implemented in various embodiments as a desired combination of one or more of hardware, software, and firmware. The description is continued with respect to an embodiment in which various features are operative when the software instructions described above are executed.

### 12. Digital Processing System

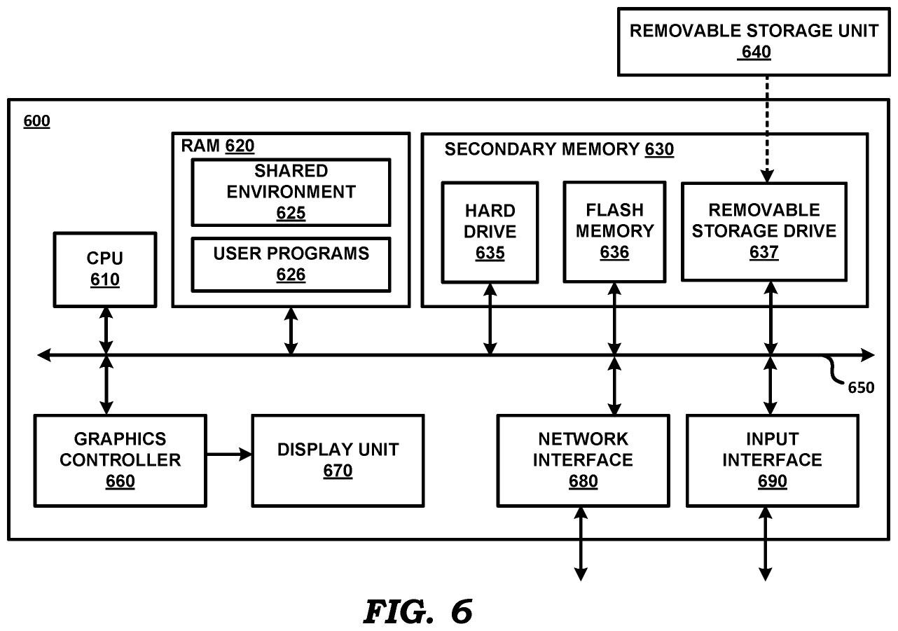

FIG. 6 is a block diagram illustrating the details of digital processing system 600 in which various aspects of the present disclosure are operative by execution of appropriate executable modules. Digital processing system 600 may correspond to any one of nodes (such as 150) of computing infrastructures 110/120, upgrade server 170 and end user systems 160.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or other user programs 626 (such as other applications, DBMS, etc.). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (of FIG. 1) connected to the network (130).

Secondary memory 630 may contain hard drive 635, flash memory 636, and removable storage drive 637. Secondary memory 630 may store the data (for example, portions of data of FIGS. 4A-4D) and software instructions (for example, for performing the steps of FIGS. 2A-2C, for implementing the modules of FIGS. 3A and 3B, etc.), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

### 13. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

1. A method implemented in a node of a distributed system, the method comprising:
operating a first version of a software module based on a first set of values for a set of configuration flags;
receiving a change request to change said software module to a second version, said change request specifying a second set of values for said set of configuration flags;
in response to said change request:
modifying, by a first time instance, said software module from said first version to said second version;
operating said second version of said software module, after said first time instance, based on said first set of values for said set of configuration flags;
receiving, at a second time instance after said first time instance, an indication to promote said set of configuration flags; and
after receipt of said indication, operating said second version of said software module based on said second set of values for said configuration flags,
wherein between said first time instance and said second time instance, said second version of said software module is operative based on said first set of values for said set of configuration flags,
wherein after said second time instance, said second version of said software module is operative based on said second set of values for said set of configuration flags.

2. The method of claim 1, wherein said software module is an instance of a plurality of instances of a software component, said plurality of instances being deployed on respective nodes in said distributed system, said respective nodes including said node,
wherein said indication is received after the completion of said modifying of all instances of said plurality of instances of said software component from said first version to said second version.

3. The method of claim 2, wherein said software component is part of a distributed database deployed in said distributed system, said distributed database when operative in said distributed system providing a distributed data service,
wherein said distributed data service is continued to be provided by said distributed system while said plurality of instances of said software component are modified from said first version to said second version.

4. The method of claim 2, wherein said set of configuration flags comprises a first configuration flag, wherein said first configuration flag is set to a first value in said first set of values and a second value in said second set of values,
said first value and said second value respectively indicating a first data format and a second data format, said first data format being different from said second data format,
wherein said second version of said software module operates with said first data format prior to said indication in view of said first configuration flag being set to said first value and with said second data format after receipt of said indication in view of said first configuration flag being set to said second value.

5. The method of claim 4, wherein said first data format and said second data format are related to one of data formats used to send data within nodes of said distributed system, data formats used to persist the data in said distributed system and data formats used to communicate with systems external to said distributed system.

6. The method of claim 2, wherein said change request specifies a second set of configuration flags, a set of initial values for said second set of configuration flags, and a set of target values for said second set of configuration flags,
wherein said second version of said software module operates based on said set of initial values for said second set of configuration flags in a duration between said first time instance and said second time instance, and operates based on said set of target values for said second set of configuration flags after receipt of said indication at said second time instance.

7. The method of claim 6, wherein said second set of configuration flags comprises a second configuration flag, wherein said second configuration flag is set to an initial value in said set of initial values and a target value in said set of target values,
said initial value indicating that a new feature is disabled, and said target value indicating that said new feature is enabled,
wherein said second version of said software module operates with said new feature only after receipt of said indication in view of said second configuration flag being set to said initial value in said duration and to said target value after receipt of said indication.

8. The method of claim 2, wherein said operating said first version and said second version of said software module comprises processing requests based on a set of current values for said set of configuration flags,
wherein said set of current values is defined to equal said first set of values prior to said indication and defined to equal said second set of values after receipt of said indication.

9. The method of claim 8, further comprising:
maintaining, in a memory in response to said change request, said second set of values and a set of promoted states corresponding to said set of configuration flags, each of said set of promoted states set to a first value indicating that the corresponding configuration flag has not been promoted;
checking, in response to said indication, which of said set of promoted states is set to said first value; and
for each promoted state set to said first value, setting the current value of the corresponding configuration flag to the corresponding value from said second set of values and said promoted state to a second value indicating that the corresponding configuration flag has been promoted.

10. A non-transitory machine-readable medium storing one or more sequences of instructions, wherein execution of said one or more instructions by one or more processors contained in a node of a distributed system cause said node to perform the actions of:
receiving a change request to change a software module from a first version to a second version, said software module being operative based on values for a set of configuration flags, said change request specifying a set of initial values and a set of target values for said set of configuration flags;
in response to said change request:
modifying, by a first time instance, said software module from said first version to said second version;
operating said second version of said software module, after said first time instance, based on said set of initial values for said set of configuration flags;
receiving, at a second time instance after said first time instance, an indication to promote said set of configuration flags; and
after receipt of said indication, operating said second version of said software module based on said set of target values for said configuration flags,
wherein between said first time instance and said second time instance, said second version of said software module is operative based on said first set of values for said set of configuration flags,
wherein after said second time instance, said second version of said software module is operative based on said second set of values for said set of configuration flags.

11. The non-transitory machine-readable medium of claim 10, wherein said software module is an instance of a plurality of instances of a software component, said plurality of instances being deployed on respective nodes in said distributed system, said respective nodes including said node,
wherein said indication is received after the completion of said modifying of all instances of said plurality of instances of said software component from said first version to said second version.

12. The non-transitory machine-readable medium of claim 11, wherein said software component is part of a distributed database deployed in said distributed system, said distributed database when operative in said distributed system providing a distributed data service,
wherein said distributed data service is continued to be provided by said distributed system while said plurality of instances of said software component are modified from said first version to said second version.

13. The non-transitory machine-readable medium of claim 11, wherein said change request is received at a third time instance prior to said first time instance,
wherein prior to said third time instance, said software module is operating based on a third set of values for said set of configuration flags,
wherein said third set of values is ignored when said operating said second version of said software module after said first time instance.

14. The non-transitory machine-readable medium of claim 11, wherein said set of configuration flags comprises a first configuration flag, wherein said first configuration flag is set to an initial value in said set of initial values and a target value in said set of target values,
said initial value indicating that a new feature is disabled, and said target value indicating that said new feature is enabled,
wherein said second version of said software module operates with said new feature only after receipt of said indication in view of said first configuration flag being set to said initial value in said duration and to said target value after receipt of said indication.

15. The non-transitory machine-readable medium of claim 11, wherein said operating said first version and said second version of said software module comprises processing requests based on a set of current values for said set of configuration flags,
wherein said set of current values is defined to equal said set of initial values prior to said indication and defined to equal said set of target values after receipt of said indication.

16. The non-transitory machine-readable medium of claim 15, further comprising one or more instructions to perform the actions of:
maintaining, in a memory in response to said change request, said set of initial values, said set of target values and a set of promoted states corresponding to said set of configuration flags, each of said set of promoted states set to a first value indicating that the corresponding configuration flag has not been promoted;
checking, in response to said indication, which of said set of promoted states is set to said first value; and
for each promoted state set to said first value, setting the current value of the corresponding configuration flag to the corresponding value from said set of target values and said promoted state to a second value indicating that the corresponding configuration flag has been promoted.

17. A node of a distributed system, the node comprising:
a random access memory (RAM) to store instructions; and
one or more processors to retrieve and execute the instructions, wherein execution of the instructions causes the digital processing system to perform the actions of:
operating a first version of a software module based on a first set of values for a set of configuration flags;
receiving a change request to change said software module to a second version, said change request specifying a second set of values for said set of configuration flags;
in response to said change request:
modifying, by a first time instance, said software module from said first version to said second version;
operating said second version of said software module, after said first time instance, based on said first set of values for said set of configuration flags;
receiving, at a second time instance after said first time instance, an indication to promote said set of configuration flags; and
after receipt of said indication, operating said second version of said software module based on said second set of values for said configuration flags,
wherein between said first time instance and said second time instance, said second version of said software module is operative based on said first set of values for said set of configuration flags,
wherein after said second time instance, said second version of said software module is operative based on said second set of values for said set of configuration flags.

18. The digital processing system of claim 17, wherein said software module is an instance of a plurality of instances of a software component, said plurality of instances being deployed on respective nodes in said distributed system, said respective nodes including said node,
wherein said indication is received after the completion of said modifying of all instances of said plurality of instances of said software component from said first version to said second version.

19. The digital processing system of claim 18, wherein said software component is part of a distributed database deployed in said distributed system, said distributed database when operative in said distributed system providing a distributed data service,
wherein said distributed data service is continued to be provided by said distributed system while said plurality of instances of said software component are modified from said first version to said second version.

20. The digital processing system of claim 18, wherein said change request specifies a second set of configuration flags, a set of initial values for said second set of configuration flags, and a set of target values for said second set of configuration flags,
wherein said second version of said software module operates based on said set of initial values for said second set of configuration flags in a duration between said first time instance and said second time instance, and operates based on said set of target values for said second set of configuration flags after receipt of said indication at said second time instance.

21. The digital processing system of claim 18, wherein said operating said first version and said second version of said software module comprises processing requests based on a set of current values for said set of configuration flags,
wherein said set of current values is defined to equal said first set of values prior to said indication and defined to equal said second set of values after receipt of said indication.
